(19) United States
(12) Patent Application Publication
(10) Pub. No.: US 2017/0077659 A1
(43) Pub. Date: Mar. 16, 2017

(54) COAXIAL CABLE CONNECTOR WITH INTEGRAL RFI PROTECTION

(71) Applicant: Corning Optical Communications RF LLC, Glendale, AZ (US)

(72) Inventors: Donald Andrew Burris, Peoria, AZ (US); Guy Joachin Castonguay, Peoria, AZ (US); Thomas Dewey Miller, Peoria, AZ (US)

(21) Appl. No.: 15/342,598

(22) Filed: Nov. 3, 2016

Related U.S. Application Data
(63) Continuation of application No. 14/928,552, filed on Oct. 30, 2015, now Pat. No. 9,548,572.
(60) Provisional application No. 62/074,323, filed on Nov. 3, 2014.

(51) Int. Cl. H01R 24/40; H01R 13/6593

(52) U.S. Cl. CPC H01R 24/40; H01R 13/6593; H01R 2103/00

(57) ABSTRACT

A coaxial cable connector comprising an assembled coupler, body, and post is provided. The back end of the post and the back end of the body are adapted to receive an end of a coaxial cable. The coupler further comprises a central passage, a lip with a forward facing surface and a rearward facing surface, and a bore forward of the lip, and is adapted to couple the connector to a coaxial cable terminal. The post further comprises a collar portion and an enlarged shoulder disposed forward of the lip of the coupler within the bore of the coupler. The enlarged shoulder of the post is disposed forward of the collar portion of the post. A contacting portion of the post comprises an extension of the collar portion of the post and at least a portion of the enlarged shoulder of the post comprises a proximity feature.

### CROSS REFERENCE TO RELATED APPLICATIONS

This application is a continuation of U.S. patent application Ser. No. 14/928,552, filed Oct. 30, 2015, which claims the benefit of U.S. Provisional Application Ser. No. 62/074,323, filed Nov. 3, 2014, the contents of which are incorporated herein by reference.

### BACKGROUND

Field of the Disclosure

The technology of the disclosure relates to coaxial cable connectors and, in particular, to a coaxial cable connector that provides integral radio frequency interference (RFI) shielding.

Technical Background

Coaxial cable connectors, such as type F connectors, are used to attach coaxial cable to another object or appliance, e.g., a television set, DVD player, modem or other electronic communication device having a terminal adapted to engage the connector. The terminal of the appliance includes an inner conductor and a surrounding outer conductor.

Coaxial cable includes a center conductor for transmitting a signal. The center conductor is surrounded by a dielectric material, and the dielectric material is surrounded by an outer conductor; this outer conductor may be in the form of a conductive foil and/or braided sheath. The outer conductor is typically maintained at ground potential to shield the signal transmitted by the center conductor from stray noise, and to maintain a continuous desired impedance over the signal path. The outer conductor is usually surrounded by a plastic cable jacket that electrically insulates, and mechanically protects, the outer conductor. Prior to installing a coaxial connector onto an end of the coaxial cable, the end of the coaxial cable is typically prepared by stripping off the end portion of the jacket to expose the end portion of the outer conductor. Similarly, it is common to strip off a portion of the dielectric to expose the end portion of the center conductor.

Coaxial cable connectors of the type known in the trade as “F connectors” often include a tubular post designed to slide over the dielectric material, and under the outer conductor of the coaxial cable, at the prepared end of the coaxial cable. If the outer conductor of the cable includes a braided sheath, then the exposed braided sheath is usually folded back over the cable jacket. The cable jacket and folded-back outer conductor extend generally around the outside of the tubular post and are typically received in an outer body of the connector; this outer body of the connector is often fixedly secured to the tubular post. A coupler is typically rotatably secured around the tubular post and includes an internally-threaded region for engaging external threads formed on the outer conductor of the appliance terminal.

When connecting the end of a coaxial cable to a terminal of a television set, equipment box, modem, computer or other appliance, it is important to achieve a reliable electrical connection between the outer conductor of the coaxial cable and the outer conductor of the appliance terminal. Typically, this goal is usually achieved by ensuring that the coupler of the connector is fully tightened over the connection port of the appliance. When fully tightened, the head of the tubular post of the connector directly engages the edge of the outer conductor of the appliance port, thereby making a direct electrical ground connection between the outer conductor of the appliance port and the tubular post; in turn, the tubular post is engaged with the outer conductor of the coaxial cable.

With the increased use of self-install kits provided to home owners by some CATV system operators has come a rise in customer complaints due to poor picture quality in video systems and/or poor data performance in computer/internet systems. Additionally, CATV system operators have found upstream data problems induced by entrance of unwanted radio frequency (“RF”) signals into their systems. Complaints of this nature result in CATV system operators having to send a technician to address the issue. Often times it is reported by the technician that the cause of the problem is due to a loose F connector fitting, sometimes as a result of inadequate installation of the self-install kit by the homeowner. An improperly installed or loose connector may result in poor signal transfer because there are discontinuities along the electrical path between the devices, resulting in ingress of undesired RF signals where RF energy from an external source or sources may enter the connector/cable arrangement causing a signal to noise ratio problem resulting in an unacceptable picture or data performance. In particular, RF signals may enter CATV systems from wireless devices, such as cell phones, computers and the like, especially in the 700-800 MHz transmitting range.

Many of the current state of the art F connectors rely on intimate contact between the F male connector interface and the F female connector interface. If, for some reason, the connector interfaces are allowed to pull apart from each other, such as in the case of a loose F male coupler, an interface “gap” may result. If not otherwise protected this gap can be a point of RF ingress as previously described.

A shield that completely surrounds or encloses a structure or device to protect it against RFI is typically referred to as a “Faraday cage.” However, providing such RFI shielding within given structures is complicated when the structure or device comprises moving parts, such as seen in a coaxial connector. Accordingly, creating a connector to act in a manner similar to a Faraday cage to prevent ingress and egress of RF signals can be especially challenging due to the necessary relative movement between connector components required to couple the connector to a related port. Relative movement of components due to mechanical clearances between the components can result in an ingress or egress path for unwanted RF signals and, further, can disrupt the electrical and mechanical communication between components necessary to provide a reliable ground path. The effort to shield and electrically ground a coaxial connector is further complicated when the connector is required to perform when improperly installed, i.e. not tightened to a corresponding port.

Electromagnetic interference (EMI) has been defined as undesired conducted or radiated electrical disturbances from an electrical or electronic apparatus, including transients, which can interfere with the operation of other electrical or electronic apparatus. Such disturbances can occur anywhere in the electromagnetic spectrum. Radio frequency interference (RFI) is often used interchangeably with electromagnetic interference, although it is more properly restricted to the radio frequency portion of the electromagnetic spectrum, usually defined as between 24 kilohertz (kHz) and 240 gigahertz (GHz). A shield is defined as a metallic or otherwise electrically conductive configuration inserted between a source of EMI/RFI and a desired area of protection. Such a shield may be provided to prevent electromagnetic energy from radiating from a source. Additionally, such a shield may prevent external electromagnetic energy from entering the shielded system. As a practical matter, such shields normally take the form of an electrically conductive housing which is electrically grounded. The energy of the EMI/RFI is thereby dissipated harmlessly to ground. Because EMI/RFI disrupts the operation of electronic components, such as integrated circuit (IC) chips, IC packages, hybrid components, and multi-chip modules, various methods have been used to contain EMI/RFI from electronic components. The most common method is to electrically ground a “can” that will cover the electronic components, to a substrate such as a printed wiring board. As is well known, a can is a shield that may be in the form of a conductive housing, a metallized cover, a small metal box, a perforated conductive case wherein spaces are arranged to minimize radiation over a given frequency band, or any other form of a conductive surface that surrounds electronic components. When the can is mounted on a substrate such that it completely surrounds and encloses the electronic components, it is often referred to as a Faraday Cage. Presently, there are two predominant methods to form a Faraday cage around electronic components for shielding use. A first method is to solder a can to a ground strip that surrounds electronic components on a printed wiring board (PWB). Although soldering a can provides excellent electrical properties, this method is often labor intensive. Also, a soldered can is difficult to remove if an electronic component needs to be re-worked. A second method is to mechanically secure a can, or other enclosure, with a suitable mechanical fastener, such as a plurality of screws or a clamp, for example. Typically, a conductive gasket material is usually attached to the bottom surface of a can to ensure good electrical contact with the ground strip on the PWB. Mechanically securing a can facilitates the re-work of electronic components, however, mechanical fasteners are bulky and occupy “valuable” space on a PWB.”

Coaxial cable connectors have attempted to address the above problems by incorporating a continuity member into the coaxial cable connector as a separate component. In this regard, FIG. 1 illustrates a conventional connector 1000 having a coupler 2000, a separate post 3000, a separate continuity member 4000, and a body 5000. In connector 1000 the separate continuity member 4000 is captured between post 3000 and body 5000 and contacts at least a portion of coupler 2000. Coupler 2000 is preferably made of metal such as brass and plated with a conductive material such as nickel. Post 3000 is preferably made of metal such as brass and plated with a conductive material such as tin. Separate conductive member 4000 is preferably made of metal such as phosphor bronze and plated with a conductive material such as tin. Body 5000 is preferably made of metal such as brass and plated with a conductive material such as nickel.

### SUMMARY OF THE DETAILED DESCRIPTION

According to the subject matter of the present disclosure, coaxial cable connectors are provided where the post of the connector comprises a contacting portion and a proximity feature.

In accordance with one embodiment of the present disclosure, a coaxial cable connector is provided where the connector comprises a coupler, a body, and a post. The coupler is adapted to couple the connector to a coaxial cable terminal and has an inside surface having contours. The post is assembled with the coupler and the body and is adapted to receive an end of a coaxial cable. The post comprises a contacting portion and a proximity feature which are monolithic with the post. The contacting portion forms to the contours of the coupler when the post is assembled with the coupler. The proximity feature is configured to inhibit the contacting portion from over-forming when forming to the contours of the coupler. Methods of assembling coaxial cable connectors are also contemplated.

In accordance with another embodiment of the present disclosure, a coaxial cable connector comprising an assembled coupler, body, and post is provided. The back end of the post and the back end of the body are adapted to receive an end of a coaxial cable. The coupler further comprises a central passage, a lip with a forward facing surface and a rearward facing surface, and a bore forward of the lip, and is adapted to couple the connector to a coaxial cable terminal. The post further comprises a collar portion and an enlarged shoulder disposed forward of the lip of the coupler within the bore of the coupler. The enlarged shoulder of the post is disposed forward of the collar portion of the post. A contacting portion of the post comprises an extension of the collar portion of the post and at least a portion of the enlarged shoulder of the post comprises a proximity feature. The contacting portion of the post contacts the bore of the coupler and bends towards the front end of the connector when the post is assembled with the coupler. The proximity feature is configured to inhibit a degree to which the contacting portion may bend towards the front end of the connector upon contact with the bore of the coupler.

Additional embodiments disclosed herein include a coaxial cable connector having an inner conductor, a dielectric surrounding the inner conductor, an outer conductor surrounding the dielectric, and a jacket surrounding the outer conductor and used for coupling an end of a coaxial cable to an equipment connection port. The coaxial cable connector at least partially comprises a coupler, a body and a post. The post further comprises an integral contacting portion and a proximity feature. The contacting portion and the proximity feature are monolithic with the post. The proximity feature is in juxtaposition with the contacting portion such that movement of the contacting portion induced by mechanical shock is limited or buffered by the proximity feature. The proximity feature may or may not contact the contacting portion. In the event that the proximity feature does contact the proximity feature another electrical path between the post and the coupler may be formed. Additionally, the proximity feature may serve to mechanically bolster or support the contacting portion providing mechanical and electrical communication between the post and the coupler.

Additional features and advantages are set out in the detailed description which follows, and in part will be readily apparent to those skilled in the art from that description or recognized by practicing the embodiments as described herein, including the detailed description, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a side cross sectional view of a coaxial cable connector in the prior art;

FIG. 2 is a side, cross sectional view of an exemplary embodiment of a coaxial connector comprising a post with a contacting portion providing an integral RFI and grounding shield;

FIG. 3A is side, cross-sectional view of the coaxial cable connector of FIG. 2 in a state of partial assembly;

FIG. 3B is a partial, cross-sectional detail view of the post of the coaxial cable connector of FIG. 2 in a state of further assembly than as illustrated in FIG. 3A, and illustrating the contacting portion of the post beginning to form to a contour of the coupler;

FIG. 3C is a partial, cross-sectional detail view of the post of the coaxial cable connector of FIG. 2 in a state of further assembly than as illustrated in FIGS. 3A and 3B, and illustrating the contacting portion of the post continuing to form to a contour of the coupler;

FIG. 3D is a partial, cross-sectional detail view of the post of the coaxial cable connector of FIG. 2 in a state of further assembly than as illustrated in FIGS. 3A, 3B and 3C and illustrating the contacting portion of the post forming to a contour of the coupler;

FIG. 4A is a partial, cross-sectional view of the post of the coaxial cable connector of FIG. 2 in which the post is partially inserted into a forming tool;

FIG. 4B is a partial, cross-sectional detail view of the post of the coaxial cable connector of FIG. 2 in which the post is inserted into the forming tool further than as illustrated in FIG. 4A using a forming tool and illustrating the contacting portion of the post beginning to form to a contour of the forming tool;

FIG. 4C is a partial cross-sectional detail view of the post of the coaxial cable connector of FIG. 2 in in which the post is inserted into the forming tool further than as illustrated in FIGS. 4A and 4B illustrating the contacting portion of the post continuing to form to the contour of the forming tool;

FIG. 4D is a partial cross-sectional detail view of the post of the coaxial cable connector of FIG. 2 in which the post is fully inserted into the forming tool and illustrating the contacting portion of the post forming to the contour of the forming tool;

FIGS. 5A through 5H are front and side schematic views of exemplary embodiments of the contacting portions of the post;

FIG. 6 is a cross-sectional view of an exemplary embodiment of a coaxial cable connector comprising an integral pin, wherein the coupler rotates about a body and a retainer instead of a post and the contacting portion is part of a component pressed in position in the body and forming to a contour of the coupler in the state of assembly with the retainer having a contacting portion forming to a contour of the coupler;

FIG. 6A is a cross-sectional view of the coaxial cable connector illustrated in FIG. 6 in a partial state of assembly illustrating the contacting portion of the retainer and adapted to form to a contour of the coupler;

FIG. 7 is a cross-sectional view of an exemplary embodiment of a coaxial cable connector comprising an integral pin, wherein the coupler rotates about a body instead of a post and the contacting portion is part of a component press fit into the body and forming to a contour of the coupler;

FIG. 7A is a cross-sectional view of the coaxial cable connector illustrated in FIG. 6 in a partial state of yet successively further assembly illustrating the contacting portion of the retainer and adapted to form to a contour of the coupler wherein the retainer is in an un-flared condition;

FIG. 8 is cross-sectional views of the coaxial cable connector illustrated in FIG. 6 in a partial state of still yet successively further assembly illustrating the contacting portion of the retainer and adapted to form to a contour of the coupler where in the retainer is in a final flared condition;

FIG. 9 is a cross sectional view of an exemplary embodiment of a coaxial cable connector comprising a post-less configuration, and a body having a contacting portion forming to a contour of the coupler;

FIG. 10 is a cross sectional view of an exemplary embodiment of a coaxial cable connector comprising a hex crimp body and a post having a contacting portion forming to a contour of the coupler;

FIG. 11 is an isometric, schematic view of the post of the coaxial cable connector of FIG. 2 wherein the post has a contacting portion in a formed state;

FIG. 12 is an isometric, cross-sectional view of the post and the coupler of the coaxial cable connector of FIG. 2 illustrating the contacting portion of the post forming to a contour of the coupler;

FIG. 13 is a cross-sectional view of an exemplary embodiment of a coaxial cable connector having a coupler with a contacting portion forming to a contour of the post;

FIG. 14 is a cross-sectional view of an exemplary embodiment of a coaxial cable connector having a post with a contacting portion forming to a contour of the coupler;

FIG. 15 is a cross-sectional view of an exemplary embodiment of a coaxial cable connector having a post with a contacting portion forming to a contour behind a lip in the coupler toward the rear of the coaxial cable connector;

FIG. 16 is a cross-sectional view of an exemplary embodiment of a coaxial cable connector having a post with a contacting portion forming to a contour behind a lip in the coupler toward the rear of the coaxial cable connector;

FIG. 17 is a cross-sectional view of an exemplary embodiment of a coaxial cable connector having a body with a contacting portion forming to a contour behind a lip in the coupler toward the rear of the coaxial cable connector;

FIG. 18 is a cross-sectional view of an exemplary embodiment of a coaxial cable connector having a post with a contacting portion forming to a contour of a coupler with an undercut;

FIG. 18A is a partial, cross-sectional view of an exemplary embodiment of a coaxial cable connector having a post with a contacting portion forming to a contour of a coupler with an undercut having a prepared coaxial cable inserted in the coaxial cable connector;

FIG. 19 is a partial, cross-sectional view of an exemplary embodiment of a coaxial cable connector having a moveable post with a contacting portion wherein the post is in a forward position;

FIG. 20 is a partial cross sectional view of the coaxial cable connector of FIG. 19 with the movable post in a rearward position and the contacting portion of the movable post forming to a contour of the coupler;

FIG. 21 is a side, cross sectional view of an exemplary embodiment of an assembled coaxial cable connector providing for circuitous electrical paths at the coupler to form an integral Faraday cage for RF protection;

FIG. 22 is a partial, cross-sectional detail view of the assembled coaxial cable connector of FIG. 21 illustrating a circuitous path between the coupler, post and body another circuitous path between the coupler and the equipment connection port;

FIG. 23 is a partial, cross sectional detail view of the coupler, the post and the body of FIG. 22.

FIG. 24 is a partial, cross-sectional detail view of the threads of an equipment connection port and the threads of the coupler of the assembled coaxial cable connector of FIG. 22; and

FIG. 25 is a graphic representation of the RF shielding of the coaxial cable connector in FIG. 21 in which the RF shielding is measured in dB over a range of frequency in MHz;

FIG. 26 is a side, cross sectional view of an exemplary embodiment of a partially assembled coaxial cable connector providing for circuitous electrical paths at the coupler;

FIG. 26A is a partial, cross-sectional detail view of the partially assembled coaxial cable connector of FIG. 26;

FIG. 26B is a partial, perspective cut-away view of the cable connector of FIG. 26, illustrating the coaxial connector of FIG. 26 with a contacting portion formed to the contour of the coupler with the coupler removed;

FIG. 26C is a partial, cross-sectional view of the coaxial connector of FIG. 26 showing the proximity feature as a step in the enlarged shoulder;

FIG. 26D is a partial, cross-sectional view of the coaxial connector of FIG. 26 showing the proximity feature as a chamfer in the enlarged shoulder;

FIG. 27 is a front view of a post showing the contacting portion not formed to the contour of the coupler.

FIG. 28 is side schematic view of the post having contacting portions with a contacting portion formed so as to be in proximity to the proximity feature; and

FIGS. 28A-28C are cut-away side schematic, partially sectioned external schematic and partially sectioned isometric views of an exemplary embodiment of the post having contacting portions and a proximity feature.

### DETAILED DESCRIPTION

Reference will now be made in detail to the embodiments, examples of which are illustrated in the accompanying drawings, in which some, but not all embodiments are shown. Indeed, the concepts may be embodied in many different forms and should not be construed as limiting herein. Rather, these embodiments are provided so that this disclosure will satisfy applicable legal requirements. Whenever possible, like reference numbers will be used to refer to like components or parts.

Coaxial cable connectors are used to couple a prepared end of a coaxial cable to a threaded female equipment connection port of an appliance. The coaxial cable connector may have a post, a moveable post or be postless. In each case though, in addition to providing an electrical and mechanical connection between the conductor of the coaxial connector and the conductor of the female equipment connection port, the coaxial cable connector provides a ground path from an outer conductor of the coaxial cable to the equipment connection port. The outer conductor may be, as examples, a conductive foil or a braided sheath. Maintaining a stable ground path protects against the ingress of undesired radio frequency (“RF”) signals which may degrade performance of the appliance. This is especially applicable when the coaxial cable connector is not fully tightened to the equipment connection port, either due to not being tightened upon initial installation or due to becoming loose after installation.

Embodiments disclosed herein include a coaxial cable connector having an inner conductor, a dielectric surrounding the inner conductor, an outer conductor surrounding the dielectric, and a jacket surrounding the outer conductor and used for coupling an end of a coaxial cable to an equipment connection port. The coaxial cable comprises a coupler, a body and a post. The coupler is adapted to couple the connector to the equipment connection port. The coupler has a step and a threaded portion adapted to connect with a threaded portion of the equipment connection port the post is assembled with the coupler and the body and is adapted to receive an end of a coaxial cable. The post comprises a flange, a contacting portion and a shoulder. The contacting portion is integral and monolithic with at least a portion of the post.

The post further comprises a proximity feature. The proximity feature is monolithic with the post. The proximity feature of the post is in juxtaposition with the terminal end or ends of the integral contacting portion such that movement of the integral contacting portion induced by mechanical shock is limited or buffered by the proximity feature. The terminal end or ends of the integral contacting portion may or may not contact the proximity feature in any given circumstance. In the event that the terminal end or ends of the integral contacting portion do contact the proximity feature another alternative electrical path may be formed. Additionally, the proximity feature may serve to mechanically bolster or support the terminal end or ends of the integral contacting portion ensuring mechanical and electrical communication between the integral contact portion and the coupler.

For purposes of this description, the term “forward” will be used to refer to a direction toward the portion of the coaxial cable connector that attaches to a terminal, such as an appliance equipment port. The term “rearward” will be used to refer to a direction that is toward the portion of the coaxial cable connector that receives the coaxial cable. The term “terminal” will be used to refer to any type of connection medium to which the coaxial cable connector may be coupled, as examples, an appliance equipment port, any other type of connection port, or an intermediate termination device.

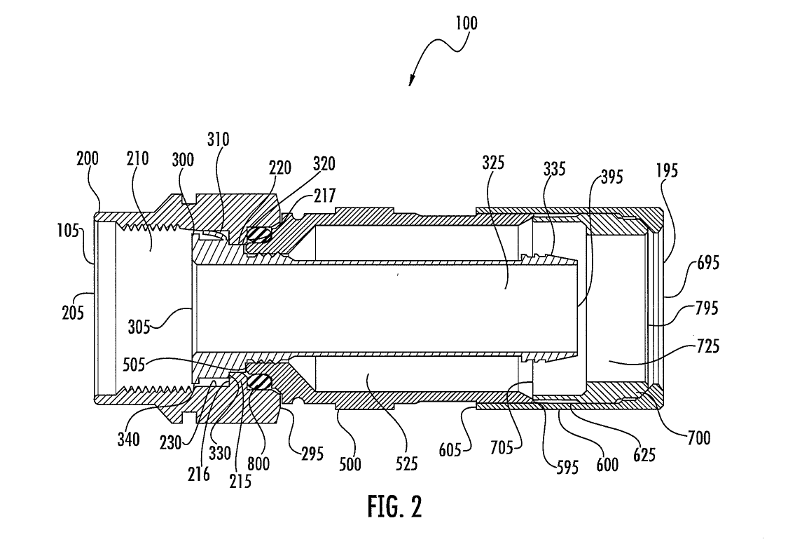

Referring now to FIG. 2, there is illustrated an exemplary embodiment of a coaxial cable connector 100. The coaxial cable connector 100 has a front end 105, a back end 195, a coupler 200, a post 300, a body 500, a shell 600 and a gripping member 700. The coupler 200 at least partially comprises a front end 205, a back end 295, a central passage 210, a lip 215 with a forward facing surface 216 and a rearward facing surface 217, a through-bore 220 formed by the lip 215, and a bore 230. Coupler 200 is preferably made of metal such as brass and plated with a conductive material such as nickel. Alternately or additionally, selected surfaces of the coupler 200 may be coated with conductive or non-conductive coatings or lubricants, or a combination thereof. Post 300, may be tubular, at least partially comprises a front end 305, a back end 395, and a contacting portion 310. In FIG. 2, contacting portion 310 is shown as a protrusion integrally formed and monolithic with post 300. Contacting portion 310 may, but does not have to be, radially projecting. Post 300 may also comprise an enlarged shoulder 340, a collar portion 320, a through-bore 325, a rearward facing annular surface 330, and a barbed portion 335 proximate the back end 395. The post 300 is preferably made of metal such as brass and plated with a conductive material such as tin. Additionally, the material, in an exemplary embodiment, may have a suitable spring characteristic permitting contacting portion 310 to be flexible, as described below. Alternately or additionally, selected surfaces of post 300 may be coated with conductive or non-conductive coatings or lubricants or a combination thereof. Contacting portion 310, as noted above, is monolithic with post 300 and provides for electrical continuity through the connector 100 to an equipment port (not shown in FIG. 2) to which connector 100 may be coupled. In this manner, post 300 provides for a stable ground path through the connector 100, and, thereby, electromagnetic shielding to protect against the ingress and egress of RF signals. Body 500 at least partially comprises a front end 505, a back end 595, and a central passage 525. Body 500 is preferably made of metal such as brass and plated with a conductive material such as nickel. Shell 600 at least partially comprises a front end 605, a back end 695, and a central passage 625. Shell 600 is preferably made of metal such as brass and plated with a conductive material such as nickel. Gripping member 700 at least partially comprises a front end 705, a back end 795, and a central passage 725. Gripping member 700 is preferably made of a suitable polymer material such as acetyl or nylon. The resin can be selected from thermoplastics characterized by good fatigue life, low moisture sensitivity, high resistance to solvents and chemicals, and good electrical properties.

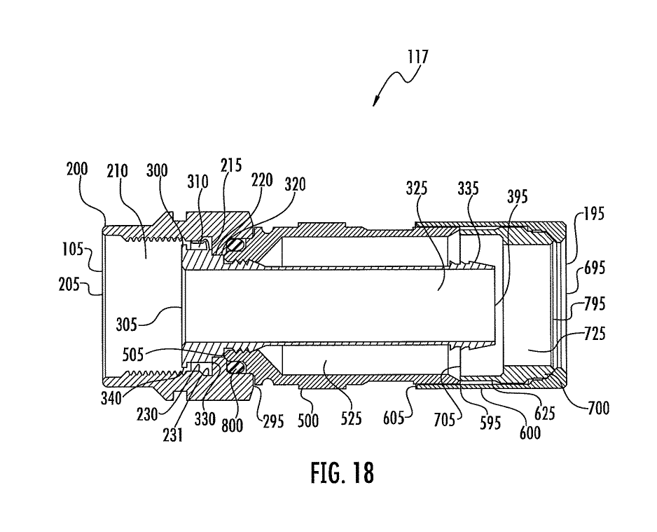

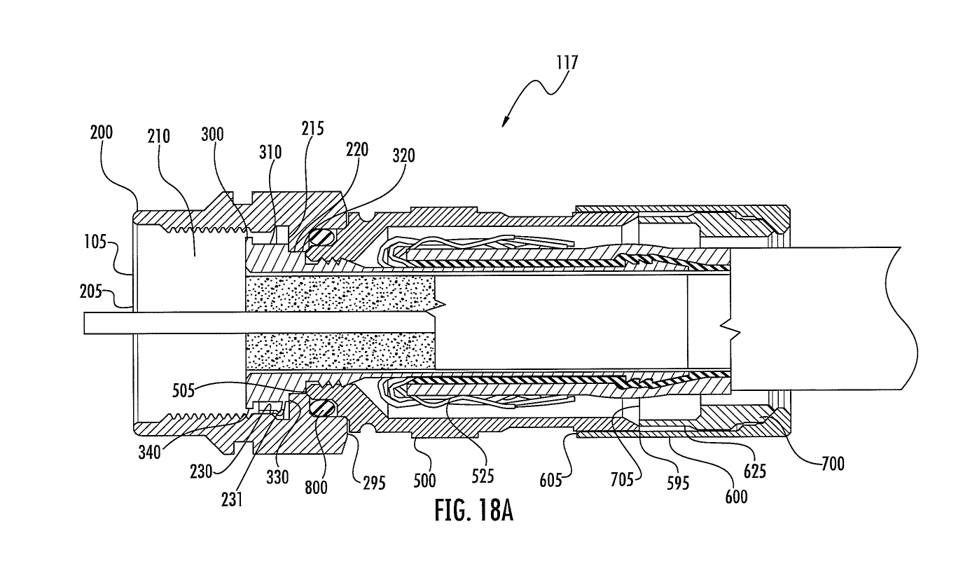

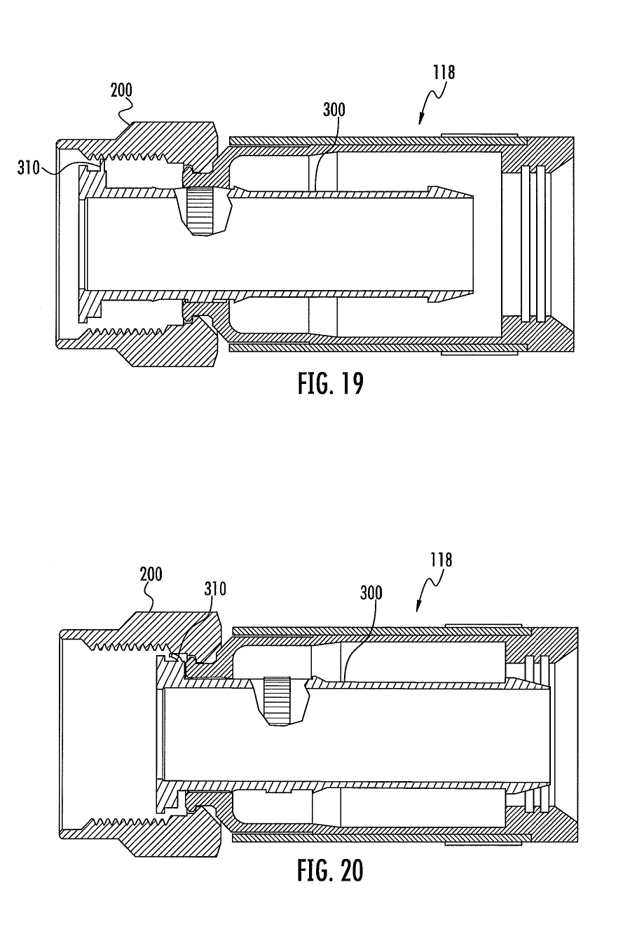

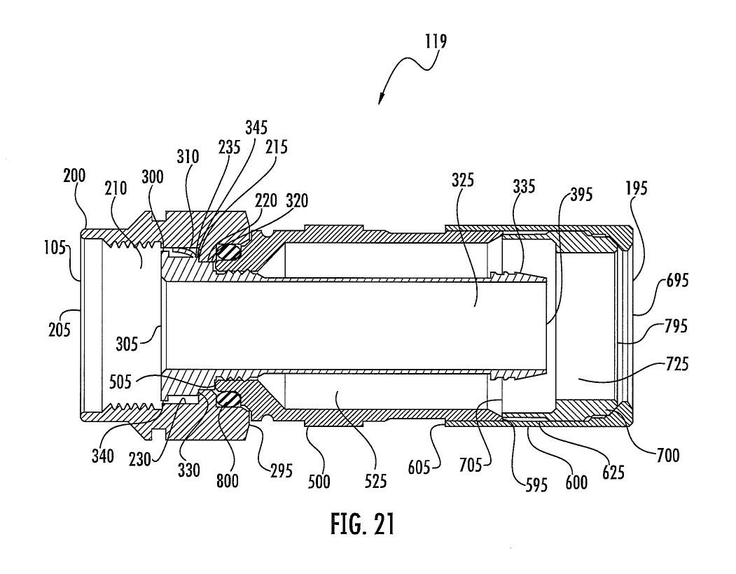

In FIG. 2, coaxial cable connector 100 is shown in an unattached, uncompressed state, without a coaxial cable inserted therein. Coaxial cable connector 100 couples a prepared end of a coaxial cable to a terminal, such as a threaded female equipment appliance connection port (not shown in FIG. 2). This will be discussed in more detail with reference to FIG. 18A. Shell 600 slideably attaches to body 500 at back end 595 of body 500. Coupler 200 attaches to coaxial cable connector 100 at back end 295 of coupler 200. Coupler 200 may rotatably attach to front end 305 of post 300 while engaging body 500 by means of a press-fit. Front end 305 of post 300 positions in central passage 210 of coupler 200 and has a back end 395 which is adapted to extend into a coaxial cable. Proximate back end 395, post 300 has a barbed portion 335 extending radially outwardly from post 300. An enlarged shoulder 340 at front end 305 extends inside the coupler 200. Enlarged shoulder 340 comprises a collar portion 320 and a rearward facing annular surface 330. Collar portion 320 allows coupler 200 to rotate by means of a clearance fit with through-bore 220 of coupler 200. Rearward facing annular surface 330 limits forward axial movement of the coupler 200 by engaging forward facing surface 216 of lip 215. Coaxial cable connector 100 may also include a sealing ring 800 seated within coupler 200 to form a seal between coupler 200 and body 500.

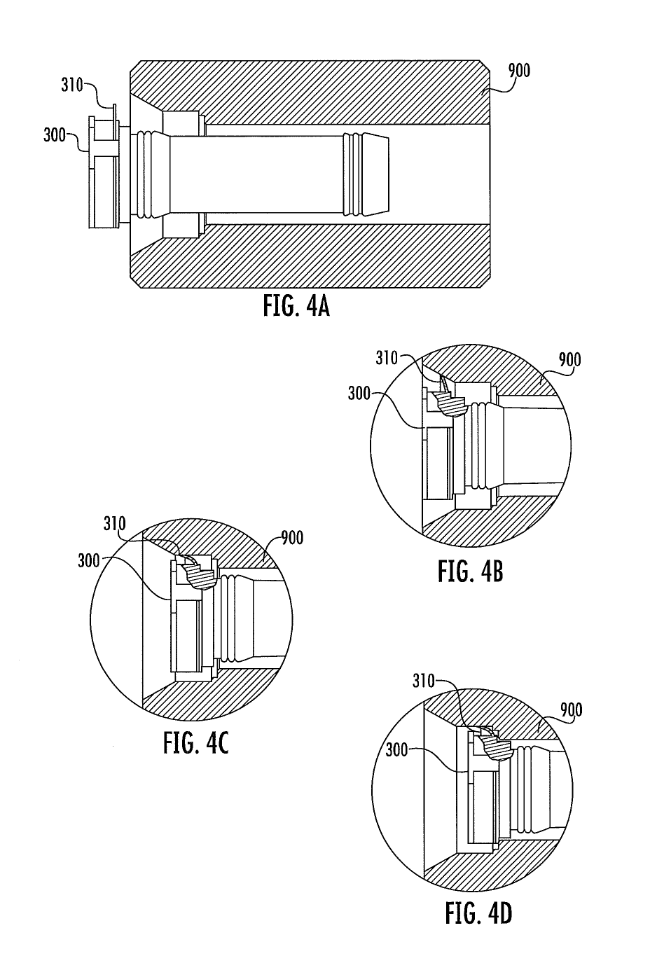

Contacting portion 310 may be monolithic with or a unitized portion of post 300. As such, contacting portion 310 and post 300 or a portion of post 300 may be constructed from a single piece of material. The contacting portion 310 may contact coupler 200 at a position that is forward of forward facing surface 216 of lip 215. In this way, contacting portion 310 of post 300 provides an electrically conductive path between post 300, coupler 200 and body 500. This enables an electrically conductive path from coaxial cable through coaxial cable connector 100 to terminal providing an electrical ground and a shield against RF ingress and egress. Contacting portion 310 is formable such that as the coaxial cable connector 100 is assembled, contacting portion 310 may form to a contour of coupler 200. In other words, coupler 200 forms or shapes contacting portion 310 of post 300. The forming and shaping of the contacting portion 310 may have certain elastic/plastic properties based on the material of contacting portion 310. Contacting portion 310 deforms, upon assembly of the components of coaxial cable connector 100, or, alternatively contacting portion 310 of post 300 may be pre-formed, or partially preformed to electrically contactedly fit with coupler 200 as explained in greater detail with reference to FIG. 4A through FIG. 4D, below. In this manner, post 300 is secured within coaxial cable connector 100, and contacting portion 310 establishes an electrically conductive path between body 500 and coupler 200. Further, the electrically conductive path remains established regardless of the tightness of the coaxial cable connector 100 on the terminal due to the elastic/plastic properties of contacting portion 310. This is due to contacting portion 310 maintaining mechanical and electrical contact between components, in this case, post 300 and coupler 200, notwithstanding the size of any interstice between the components of the coaxial cable connector 100. In other words, contacting portion 310 is integral to and maintains the electrically conductive path established between post 300 and coupler 200 even when the coaxial cable connector 100 is loosened and/or partially disconnected from the terminal, provided there is some contact of coupler 200 with equipment port. Although coaxial connector 100 in FIG. 2 is an axial-compression type coaxial connector having a post 300, contacting portion 310 may be integral to and monolithic with any type of coaxial cable connector and any other component of a coaxial cable connector, examples of which will be discussed herein with reference to the embodiments. However, in all such exemplary embodiments, contacting portion 310 provides for electrical continuity from an outer conductor of a coaxial cable received by coaxial cable connector 100 through coaxial cable connector 100 to a terminal, without the need for a separate component. Additionally, the contacting portion 310 provides for electrical continuity regardless of how tight or loose the coupler is to the terminal. In other words, contacting portion 310 provides for electrical continuity from the outer conductor of the coaxial cable to the terminal regardless and/or irrespective of the tightness or adequacy of the coupling of the coaxial cable connector 100 to the terminal. It is only necessary that the coupler 200 be in contact with the terminal.

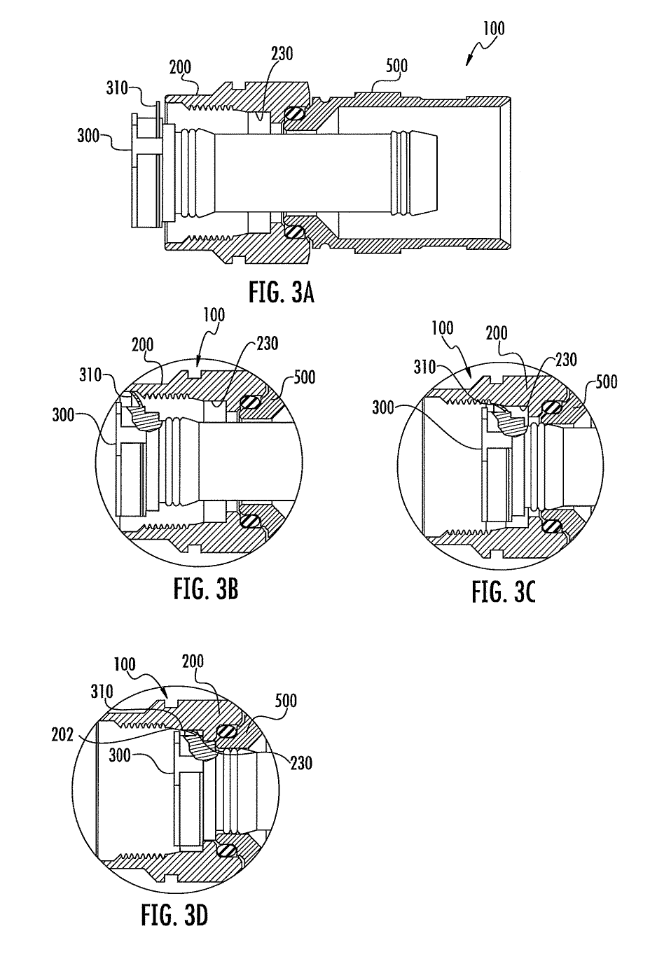

Referring now to FIGS. 3A, 3B 3C and 3D, post 300 is illustrated in different states of assembly with coupler 200 and body 500. In FIG. 3A, post 300 is illustrated partially assembled with coupler 200 and body 500 with contacting portion 310 of post 300, shown as a protrusion, outside and forward of coupler 200. Contacting portion 310 may, but does not have to be, radially projecting. In FIG. 3B, contacting portion 310 has begun to advance into coupler 200 and contacting portion 310 is beginning to form to a contour of coupler 200. As illustrated in FIG. 3B, contacting portion 310 is forming to an arcuate or, at least, a partially arcuate shape. As post 300 is further advanced into coupler 200 as shown in FIG. 3C, contacting portion 310 continues to form to the contour of coupler 200. When assembled as shown in FIG. 3D, contacting portion 310 is forming to the contour of coupler 200 and is contactedly engaged with bore 230 accommodating tolerance variations with bore 230. In FIG. 3D coupler 200 has a face portion 202 that tapers. The face portion 202 guides the contacting portion 310 to its formed state during assembly in a manner that does not compromise its structural integrity, and, thereby, its elastic/plastic property. Face portion 202 may be or have other structural features, as a non-limiting example, a curved edge, to guide the contacting portion 310. The flexible or resilient nature of the contacting portion 310 in the formed state as described above, permits coupler 200 to be easily rotated and yet maintain a reliable electrically conductive path. It should be understood, that contacting portion 310 is formable and, as such, may exist in an unformed and a formed state based on the elastic/plastic property of the material of contacting portion 310. As the coaxial cable connector 100 assembles contacting portion 310 transition from an unformed state to a formed state.

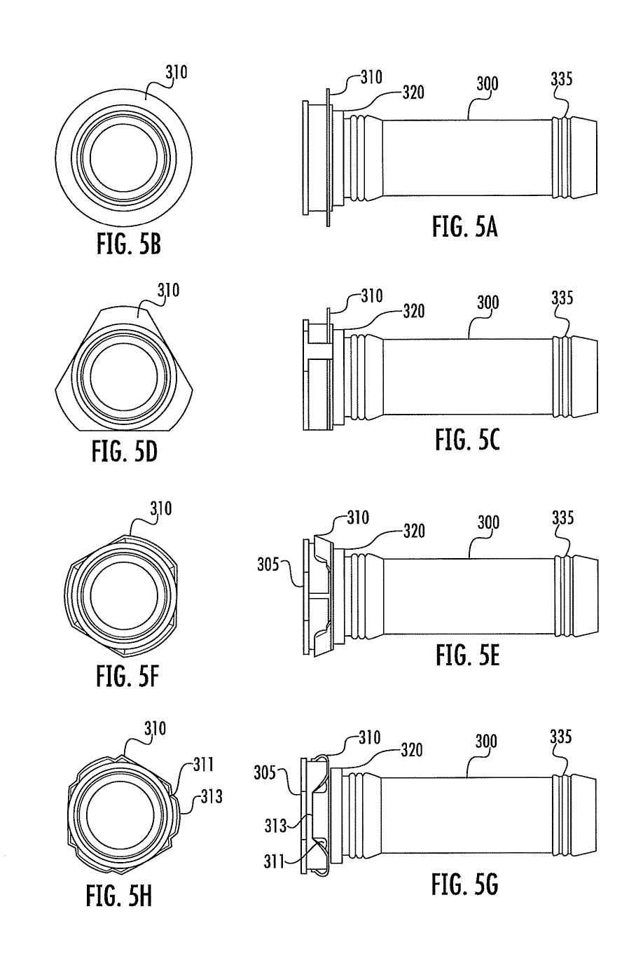

Referring now to FIGS. 4A, 4B, 4C and 4D the post 300 is illustrated in different states of insertion into a forming tool 900. In FIG. 4A, post 300 is illustrated partially inserted in forming tool 900 with contacting portion 310 of post 300 shown as a protrusion. Protrusion may, but does not have to be radially projecting. In FIG. 4B, contacting portion 310 has begun to advance into forming tool 900. As contacting portion 310 is advanced into forming tool 900, contact portion 310 begins flexibly forming to a contour of the interior of forming tool 900. As illustrated in FIG. 4B, contacting portion 310 is forming to an arcuate or, at least, a partially arcuate shape. As post 300 is further advanced into forming tool 900 as shown in FIG. 4C, contacting portion 310 continues forming to the contour of the interior of forming tool 900. At a final stage of insertion as shown in FIG. 4C contacting portion 310 is fully formed to the contour of forming tool 900, and has experienced deformation in the forming process but retains spring or resilient characteristics based on the elastic/plastic property of the material of contacting portion 310. Upon completion or partial completion of the forming of contacting portion 310, post 300 is removed from forming tool 900 and may be subsequently installed in the connector 100 or other types of coaxial cable connectors. This manner of forming or shaping contacting portion 310 to the contour of forming tool 900 may be useful to aid in handling of post 300 in subsequent manufacturing processes, such as plating for example. Additionally, use of this method makes it possible to achieve various configurations of contacting portion 310 formation as illustrated in FIGS. 5A through 5H. FIG. 5A is a side schematic view of an exemplary embodiment of post 300 where contacting portion 310 is a radially projecting protrusion that completely circumscribes post 300. In this view, contacting portion 310 is formable but has not yet been formed to reflect a contour of coaxial cable connector or forming tool. FIG. 5B is a front schematic view of the post 300 of FIG. 5. FIG. 5C is a side schematic view of an exemplary embodiment of post 300 where contacting portion 310 has a multi-cornered configuration. Contacting portion 310 may be a protrusion and may, but does not have to be, radially projecting. Although in FIG. 5C contacting portion 310 is shown as tri-cornered, contacting portion 310 can have any number of corner configurations, as non-limiting examples, two, three, four, or more. In FIG. 5C, contacting portion 310 may be formable but has not yet been formed to reflect a contour of coaxial cable connector or forming tool. FIG. 5D is a front schematic view of post 300 of FIG. 5C. FIG. 5E is a side schematic view of post 300 where contacting portion 310 has a tri-cornered configuration. In this view, contacting portion 310 is shown as being formed to a shape in which contacting portion 310 cants or slants toward the front end 305 of post 300. FIG. 5F is a front schematic view of post 300 of FIG. 5E. FIG. 5G is a side schematic view of an exemplary embodiment of post 300 where contacting portion 310 has a tri-cornered configuration. In this view contacting portion 310 is formed in a manner differing from FIG. 5E in that indentations 311 in contacting portion 310 result in a segmented or reduced arcuate shape 313. FIG. 5H is a front schematic view of post 300 of FIG. 5G.

Contacting portion 310 as illustrated in FIGS. 2-5H may be integral to and monolithic with post 300. Additionally, contacting portion 310 may have or be any shape, including shapes that may be flush or aligned with other portions of post 300, or may have any number of configurations, as non-limiting examples, configurations ranging from completely circular to multi-cornered geometries, and still perform its function of providing electrical continuity. Further, contacting portion 310 may be formable and formed to any shape or in any direction.

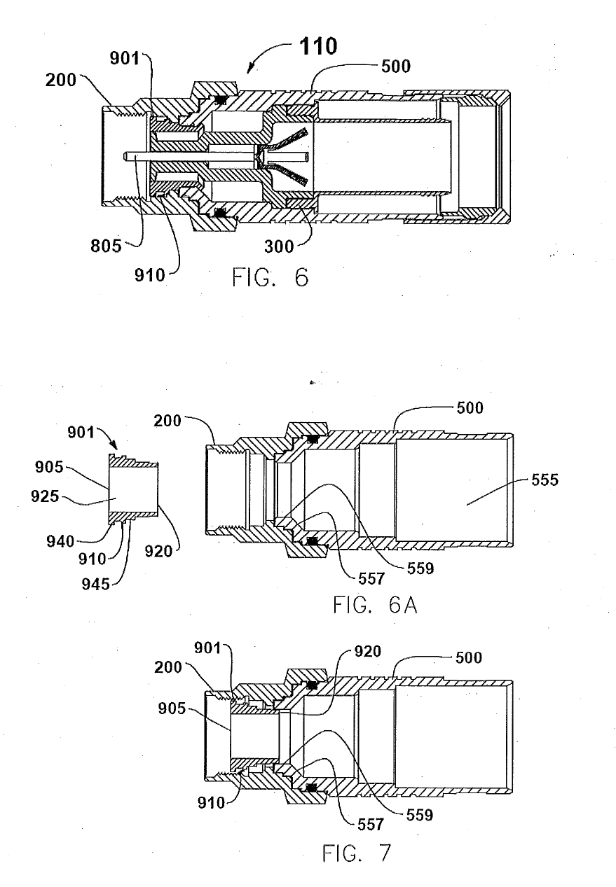

FIG. 6 FIG. 6 is a cross-sectional view of an exemplary embodiment of a coaxial cable connector 110 configured to accept a coaxial cable and comprising an integral pin 805. In the embodiment illustrated in FIG. 6, coupler 200 rotates about body 500 and retainer 901 instead of post 300 and contacting portion 910 is a protrusion integral to and monolithic with retainer 901 instead of post 300. Retainer 901 may be tubular and may partially comprise a front end 905, a back end 920, and a contacting portion 910. In FIG. 6, contacting portion 910 is shown as a protrusion integrally formed and monolithic with retainer 901. Contacting portion 910 may, but does not have to be, radially projecting. In this regard, contacting portion 910 may be a unitized portion of retainer 901. As such, contacting portion 910 may be constructed with retainer 901 from a single piece of material. Retainer 901 may be made of metal such as brass and plated with a conductive material such as tin. Retainer 901 may also comprise an enlarged shoulder 940, a collar portion 945, and a through-bore 925. Contacting portion 910 may be formed to a contour of coupler 200 as retainer 901 is assembled with body 500 as illustrated in FIG. 6A through FIG. 8.

FIG. 6A is a cross-sectional view of the coaxial cable connector illustrated in FIG. 6 in a partial state of assembly illustrating the contacting portion 910 of the retainer 901 and adapted to form to a contour of the coupler 200. As shown in FIG. 6A, contacting portion 910 has not yet been formed to a contour of the coupler 200.

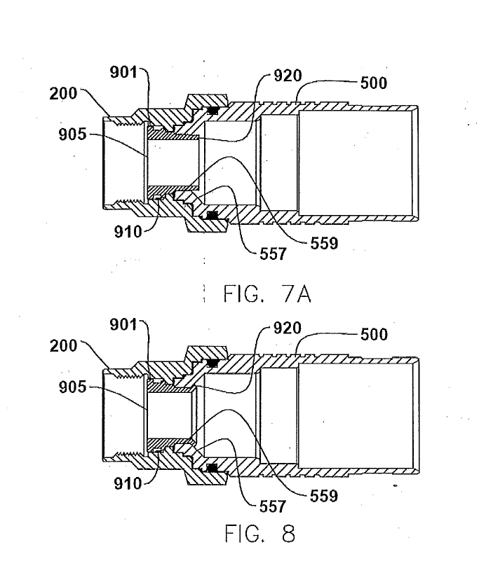

FIG. 7 is a cross-sectional view of the coaxial cable connector illustrated in FIG. 6 in a partial state of successively further assembly illustrating the contacting portion 910 of retainer 901 adapted to form to a contour of coupler 200. Assembling the retainer 901 with the body 500 (as seen successively in FIGS. 7A and 8) forms the contacting portion 910 in a manner similar to embodiments having a post 300 with a contacting portion 310 as previously described. As with contacting portion 310, the material of contacting portion 910 has a certain elastic/plastic property which, as contacting portion 910 is formed provides that contacting portion 910 will press against the contour of the coupler 200 and maintain mechanical and electrical contact with coupler 200. Contacting portion 910 provides for electrical continuity from the outer conductor of the coaxial cable to the terminal regardless of the tightness or adequacy of the coupling of the coaxial cable connector 110 to the terminal, and regardless of the tightness of the coaxial cable connector 110 on the terminal in the same way as previously described with respect to contacting portion 310.

FIG. 7A is a cross-sectional view of the coaxial cable connector illustrated in FIG. 6 in a partial state of yet successively further assembly illustrating the contacting portion 910 of the retainer 901 adapted to form to a contour of the coupler 200 wherein the retainer 901 is in an un-flared condition. Retainer 901 is press fit into body 500 which causes contacting portion 910 to form to the contour of coupler 200.

FIG. 8 is a cross-sectional view of the coaxial cable connector illustrated in FIG. 6 in a partial state of yet still successively further assembly illustrating the contacting portion 910 of the retainer 901 adapted to form to a contour of the coupler 200 wherein the retainer 901 is in a flared condition. When the retainer 901 is press-fit into body 500, back end 920 of retainer 901 is flared within the contours 559 of body 500. Flaring of back end secures retainer 901 within body 500. Contacting portion 910 as illustrated in FIGS. 6-8 may be integral to the retainer 901 or may be attached to or be part of another component. Additionally, the contacting portion 910 may have or be any shape, including shapes that may be flush or aligned with other portions of the body 500 and/or another component, or may have any number of configurations, as non-limiting examples, configurations ranging from completely circular to multi-cornered geometries.

FIG. 9 is a cross-sectional view of an embodiment of a coaxial cable connector 112 that is a compression type of connector with no post. In other words, having a post-less configuration. The coupler 200 rotates about body 500 instead of a post. The body 500 comprises contacting portion 510. The contacting portion 510 is integral with the body 500. As such, the contacting portion 510 may be constructed from a single piece of material with the body 500 or a portion of the body 500. The contacting portion 510 forms to a contour of the coupler 200 when the coupler 200 is assembled with the body 500.

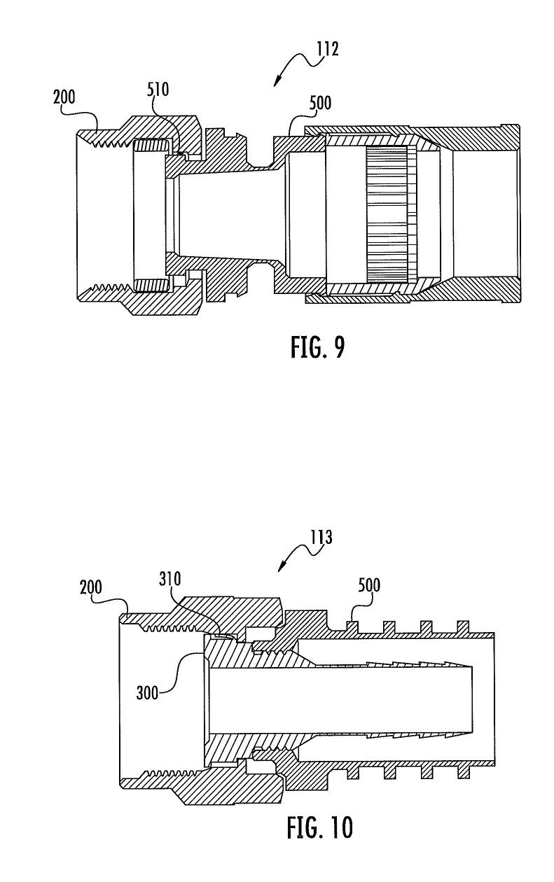

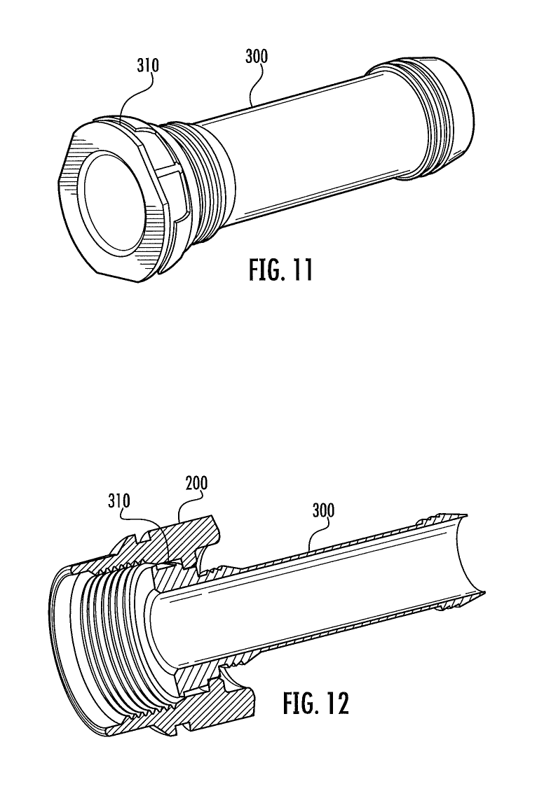

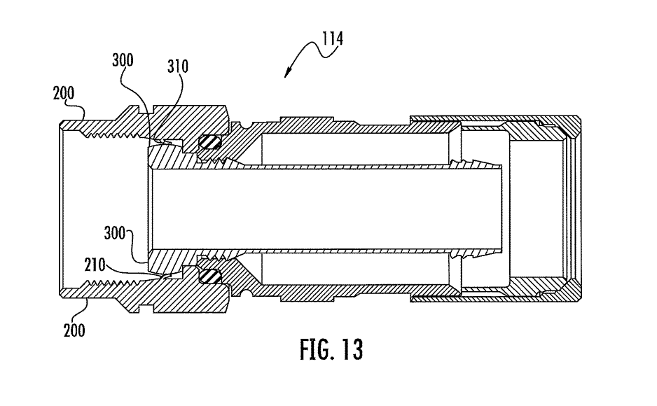

FIG. 10 is a cross-sectional view of an embodiment of a coaxial cable connector 113 that is a hex-crimp type connector. The coaxial cable connector 113 comprises a coupler 200, a post 300 with a contacting portion 310 and a body 500. The contacting portion 310 is integral to and monolithic with post 300. Contacting portion 310 may be unitized with post 300. As such, contacting portion 310 may be constructed from a single piece of material with post 300 or a portion of post 300. Contacting portion 310 forms to a contour of coupler 200 when coupler 200 is assembled with body 500 and post 300. The coaxial cable connector 113 attaches to a coaxial cable by means radially compressing body 500 with a tool or tools known in the industry.

FIG. 11 is an isometric schematic view of post 300 of coaxial cable connector 100 in FIG. 2 with the contacting portion 310 formed to a position of a contour of a coupler (not shown).

FIG. 12 is an isometric cross sectional view of post 300 and coupler 200 of connector 100 in FIG. 2 illustrated assembled with the post 300. The contacting portion 310 is formed to a contour of the coupler 200.

FIG. 13 is a cross-sectional view of an embodiment of a coaxial cable connector 114 comprising a post 300 and a coupler 200 having a contacting portion 210. Contacting portion 210 is shown as an inwardly directed protrusion. Contacting portion 210 is integral to and monolithic with coupler 200 and forms to a contour of post 300 when post 300 assembles with coupler 200. Contacting portion 210 may be unitized with coupler 200. As such, contacting portion 210 may be constructed from a single piece of material with coupler 200 or a portion of coupler 200. Contacting portion 210 provides for electrical continuity from the outer conductor of the coaxial cable to the terminal regardless of the tightness or adequacy of the coupling of the coaxial cable connector 114 to the terminal, and regardless of the tightness of coaxial cable connector 114 on the terminal. Contacting portion 210 may have or be any shape, including shapes that may be flush or aligned with other portions of coupler 200, or may have and/or be formed to any number of configurations, as non-limiting examples, configurations ranging from completely circular to multi-cornered geometries.

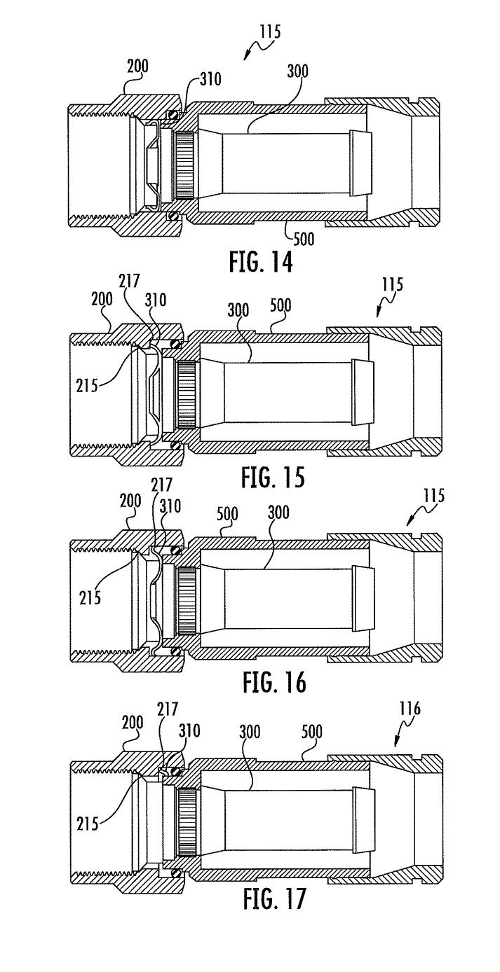

FIGS. 14, 15 and 16 are cross-sectional views of embodiments of coaxial cable connectors 115 with a post similar to post 300 comprising a contacting portion 310 as described above such that the contacting portion 310 is shown as outwardly radially projecting, which forms to a contour of the coupler 200 at different locations of the coupler 200. Additionally, the contacting portion 310 may contact the coupler 200 rearward of the lip 215, for example as shown in FIGS. 15 and 16, which may be at the rearward facing surface 217 of the lip 215, for example as shown in FIG. 15.

FIG. 17 is a cross-sectional view of an embodiment of a coaxial cable connector 116 with a body 500 comprising a contacting portion 310, wherein the contacting portion 310 is shown as an outwardly directed protrusion from body 500 that forms to the coupler 200.

FIG. 18 is a cross-sectional view of an embodiment of a coaxial cable connector 117 having a post 300 with an integral contacting portion 310 and a coupler 200 with an undercut 231. The contacting portion 310 is shown as a protrusion that forms to the contours of coupler 200 at the position of undercut 231. FIG. 18A is a cross-sectional view of the coaxial cable connector 117 as shown in FIG. 18 having a prepared coaxial cable inserted in the coaxial cable connector 117. The body 500 and the post 300 receive the coaxial cable (FIG. 18A). The post 300 at the back end 395 is inserted between an outer conductor and a dielectric layer of the coaxial cable.

FIG. 19 is a partial, cross-sectional view of an embodiment of a coaxial cable connector 118 having a post 301 comprising an integral contacting portion 310. The movable post 301 is shown in a forward position with the contacting portion 310 not formed by a contour of the coupler 200. FIG. 20 is a partial, cross-sectional view of the coaxial cable connector 118 shown in FIG. 19 with the post 301 in a rearward position and the contacting portion 310 forming to a contour of the coupler 200.

RFI shielding within given structures may be complicated when the structure or device comprises moving parts, such as a coaxial cable connector. Providing a coaxial cable connector that acts as a Faraday cage to prevent ingress and egress of RF signals can be especially challenging due to the necessary relative movement between connector components required to couple the connector to an equipment port. Relative movement of components due to mechanical clearances between the components can result in an ingress or egress path for unwanted RF signal and, further, can disrupt the electrical and mechanical communication between components necessary to provide a reliable ground path. To overcome this situation the coaxial cable connector may incorporate one or more circuitous paths that allows necessary relative movement between connector components and still inhibit ingress or egress of RF signal. This path, combined with an integral grounding flange of a component that moveably contacts a coupler acts as a rotatable or moveable Faraday cage within the limited space of a RF coaxial connector creating a connector that both shields against RFI and provides electrical ground even when improperly installed.

In this regard, FIG. 21 illustrates a coaxial cable connector 119 having front end 105, back end 195, coupler 200, post 300, body 500, compression ring 600 and gripping member 700. Coupler 200 is adapted to couple the coaxial cable connector 119 to a terminal, which includes an equipment connection port. Body 500 is assembled with the coupler 200 and post 300. The post 300 is adapted to receive an end of a coaxial cable. Coupler 200 at least partially comprises front end 205, back end 295 central passage 210, lip 215, through-bore 220, bore 230 and bore 235. Coupler 200 is preferably made of metal such as brass and plated with a conductive material such as nickel. Post 300 at least partially comprises front end 305, back end 395, contacting portion 310, enlarged shoulder 340, collar portion 320, through-bore 325, rearward facing annular surface 330, shoulder 345 and barbed portion 335 proximate back end 395. Post 300 is preferably made of metal such as brass and plated with a conductive material such as tin. Contacting portion 310 is integral and monolithic with post 300. Contacting portion 310 provides a stable ground path and protects against the ingress and egress of RF signals. Body 500 at least partially comprises front end 505, back end 595, and central passage 525. Body 500 is preferably made of metal such as brass and plated with a conductive material such as nickel. Shell 600 at least partially comprises front end 605, back end 695, and central passage 625. Shell 600 is preferably made of metal such as brass and plated with a conductive material such as nickel. Gripping member 700 at least partially comprises front end 705, back end 795, and central passage 725. Gripping member 700 is preferably made of a polymer material such as acetyl.

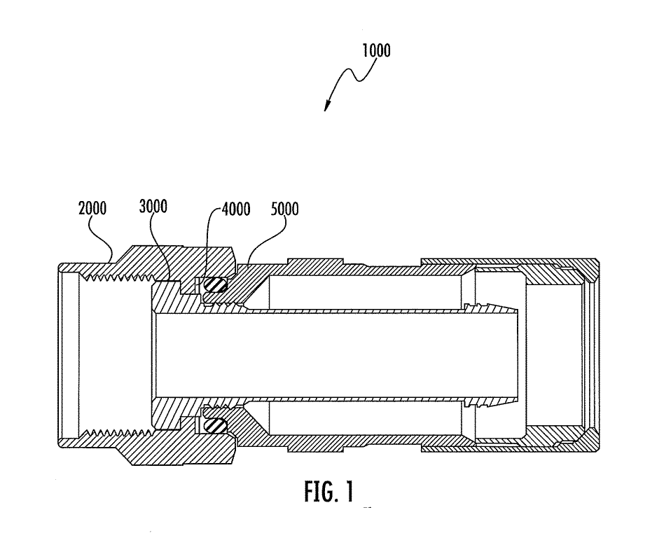

Although, coaxial cable connector 119 in FIG. 21 is an axial-compression type coaxial connector having post 300, contacting portion 310 may be incorporated in any type of coaxial cable connector. Coaxial cable connector 119 is shown in its unattached, uncompressed state, without a coaxial cable inserted therein. Coaxial cable connector 119 couples a prepared end of a coaxial cable to a threaded female equipment connection port (not shown in FIG. 21). Coaxial cable connector 119 has a first end 105 and a second end 195. Shell 600 slideably attaches to the coaxial cable connector 119 at back end 595 of body 500. Coupler 200 attaches to coaxial cable connector 119 at back end 295. Coupler 200 may rotatably attach to front end 305 of post 300 while engaging body 300 by means of a press-fit. Contacting portion 310 is of monolithic construction with post 300, being formed or constructed in a unitary fashion from a single piece of material with post 300. Post 300 rotatably engages central passage 210 of coupler 200 lip 215. In this way, contacting portion 310 provides an electrically conductive path between post 300, coupler 200 and body 500. This enables an electrically conductive path from the coaxial cable through the coaxial cable connector 119 to the equipment connection port providing an electrical ground and a shield against RF ingress. Elimination of separate continuity member 4000 as illustrated in connector 1000 of FIG. 1 improves DC contact resistance by eliminating mechanical and electrical interfaces between components and further improves DC contact resistance by removing a component made from a material having higher electrical resistance properties.

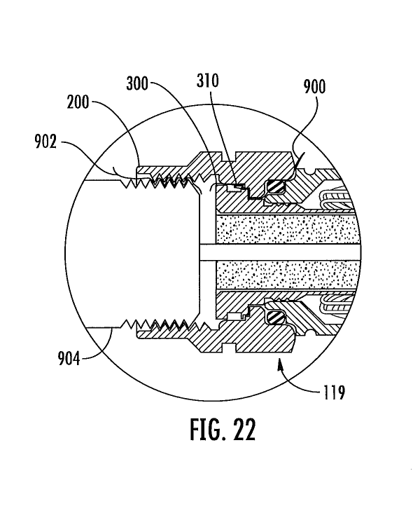

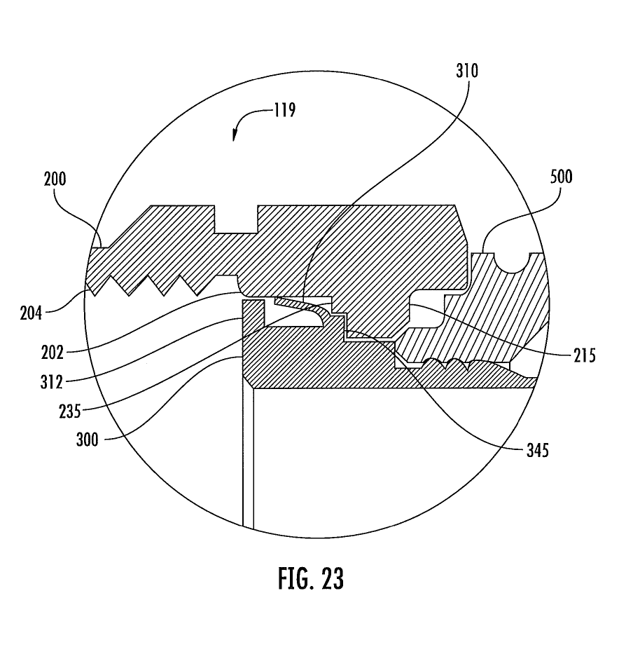

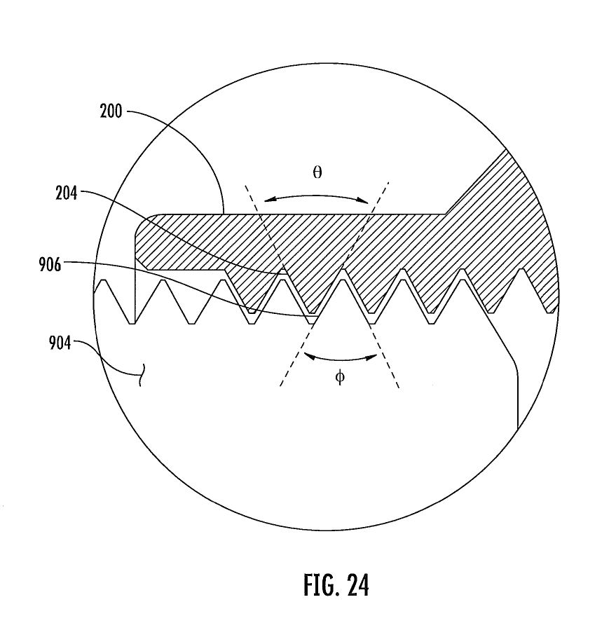

An enlarged shoulder 340 at front end 305 extends inside coupler 200. Enlarged shoulder 340 comprises flange 312, contacting portion 310, collar portion 320, rearward facing annular surface 330 and shoulder 345. Collar portion 320 allows coupler 200 to rotate by means of a clearance fit with through bore 220 of coupler 200. Rearward facing annular surface 330 limits forward axial movement of coupler 200 by engaging lip 215. Contacting portion 310 contacts coupler 200 forward of lip 215. Contacting portion 310 may be formed to contactedly fit with the coupler 200 by utilizing coupler 200 to form contacting portion 310 upon assembly of coaxial cable connector 119 components. In this manner, contacting portion 310 is secured within coaxial cable connector 119, and establishes mechanical and electrical contact with coupler 200 and, thereby, an electrically conductive path between post 300 and coupler 200. Further, contacting portion 310 remains contactedly fit, in other words in mechanical and electrical contact, with coupler 200 regardless of the tightness of coaxial cable connector 119 on the appliance equipment connection port. In this manner, contacting portion 310 is integral to the electrically conductive path established between post 300 and coupler 200 even when the coaxial cable connector 119 is loosened and/or disconnected from the appliance equipment connection port. Post 300 has a front end 305 and a back end 395. Back end 395 is adapted to extend into a coaxial cable. Proximate back end 395, post 300 has a barbed portion 335 extending radially outwardly from the tubular post 300. With reference to FIG. 22, there are shown two paths 900, 902, which depict potential RF leakage paths. Coaxial cable connector 119 includes structures to increase the attenuation of RF ingress or egress via paths 900, 902. RF leakage may occur via path 900 through coupler 200 back end 295 at the body 500 and between the lip 215 and post 300. However, as shown in FIG. 23, step 235 and shoulder 345, along with contacting portion 310 and flange 312 form a circuitous path along path 900. The structure of the coupler 200 and post 300 closes off or substantially reduces a potential RF leakage path along path 900, thereby increasing the attenuation of RF ingress or egress signals. In this way, coupler 200 and post 500 provide RF shielding such that RF signals external to the coaxial cable connector 119 are attenuated such that the integrity of an electrical signal transmitted through coaxial cable connector 119 is maintained regardless of the tightness of the coupling of the connector to equipment connection port 904.

With reference again to FIG. 22, RF leakage via path 902 may be possible along threaded portion of coupler 200 to equipment connection port 904. This is particularly true when the coaxial cable connector 119 is in a dynamic condition such as during vibration or other type of externally induced motion. Under these conditions electrical ground can be lost and an RF ingress path opened when the threads 204 of the coupler 200 and the threads 906 of the equipment connection port 904 become coaxially aligned reducing or eliminating physical contact between the coupler 200 and the equipment connection port 904. By modifying the form of the coupler 200 threads 204 the tendency of the coupler 200 to equipment connection port 904 to lose ground contact and open an RF ingress path via path 902 is mitigated, thereby increasing the attenuation of RF ingress or egress signals.

The structure of the threads 204 of the coupler 200 may involve aspects including, but are not limited to, pitch diameter of the thread, major diameter of the thread, minor diameter of the thread, thread pitch angle “θ”, thread pitch depth, and thread crest width and thread root radii. Typically, the pitch angle “θ” of thread 204 of coupler 200 is designed to match, as much as possible, the pitch angle “φ” of thread 906 of equipment connection port 904. As shown in FIG. 24, pitch angle “θ” may be different than pitch angle “φ” to reduce interfacial gap between thread 204 of coupler 200 and thread 906 of equipment connection port 904. In this way, the threaded portion of the coupler 200 traverses a shorter distance before contacting the threaded portion of the equipment connection port 904 closing off or substantially reducing a potential RF leakage path along path 902. Typically, thread 906 angle “φ” of the equipment connection port 904 is set at 60 degrees. As a non-limiting example, instead of designing coupler 200 with threads 204 of angle “θ”, angle “θ” may be set at about 62 degrees which may provide the reduced interfacial gap as discussed above. In this way, coupler 200 and post 500 provide RF shielding such that RF signals external to the coaxial cable connector 119 are attenuated such that the integrity of an electrical signal transmitted through coaxial cable connector 119 is maintained regardless of the tightness of the coupling of the connector to equipment connection port 904.

Typically, RF signal leakage is measured by the amount of signal loss expressed in decibel (“dB”). Therefore, “dB” relates to how effectively RF shielding is attenuating RF signals. In this manner, RF signal ingress into a coaxial cable connector 119 or egress out from a coaxial cable connector 119 may be determined, and, thereby, the ability of the RF shielding of a coaxial cable connector 119 to attenuate RF signals external to the coaxial cable connector 119. Accordingly, the lower the value of “dB” the more effective the attenuation. As an example, a measurement RF shielding of −20 dB would indicate that the RF shield attenuates the RF signal by 20 dB as compared at the transmission source. For purposes herein, RF signals external to the coaxial cable connector 119 include either or both of RF signal ingress into a coaxial cable connector 119 or egress out from a coaxial cable connector 119.

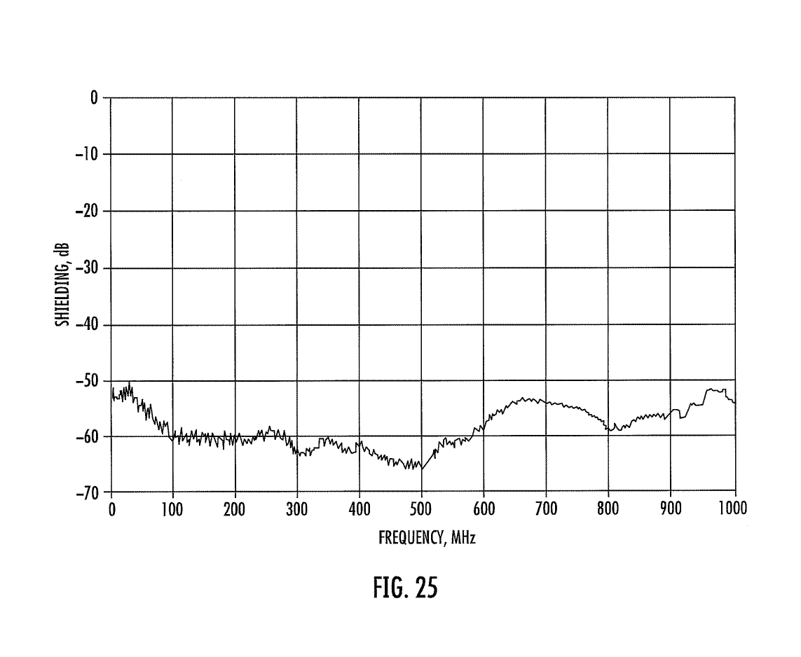

Referring now to FIG. 25, illustrates comparative RF shielding effectiveness in “dB” of coaxial cable connector 119 over a range of 0-1000 megahertz (“MHz”). The coupling 200 was finger tightened on the equipment connection port 904 and then loosened two full turns. As illustrated in FIG. 25, the RF shielding in “dB” for coaxial cable connector 119 for all frequencies tested indicated that the RF signal was attenuated by more than 50 dB.

Additionally, the effectiveness of RF signal shielding may be determined by measuring transfer impedance of the coaxial cable connector. Transfer impedance is the ratio of the longitudinal voltage developed on the secondary side of a RF shield to the current flowing in the RF shield. If the shielding effectiveness of a point leakage source is known, the equivalent transfer impedance value can be calculated using the following calculation:

SE=20 log Zₜₒₜₐₗ−45.76 (dB)

Accordingly, using this calculation the average equivalent transfer impedance of the coaxial cable connector 119 is about 0.24 ohms.

As discussed above, electrical continuity shall mean DC contact resistance from the outer conductor of the coaxial cable to the equipment port of less than about 3000 milliohms. In addition to increasing the attenuation of RF signals by closing off or reducing the RF leakage via paths 900, 902, the DC contact resistance may be substantially reduced. As a non-limiting example, the DC contact resistance may be less than about 100 milliohms, and preferably less than 50 milliohms, and more preferably less than 30 milliohms, and still more preferably less than 10 milliohms.

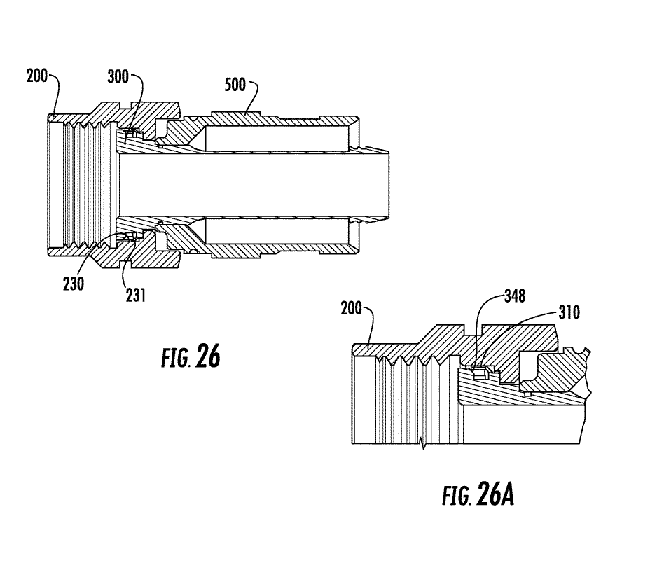

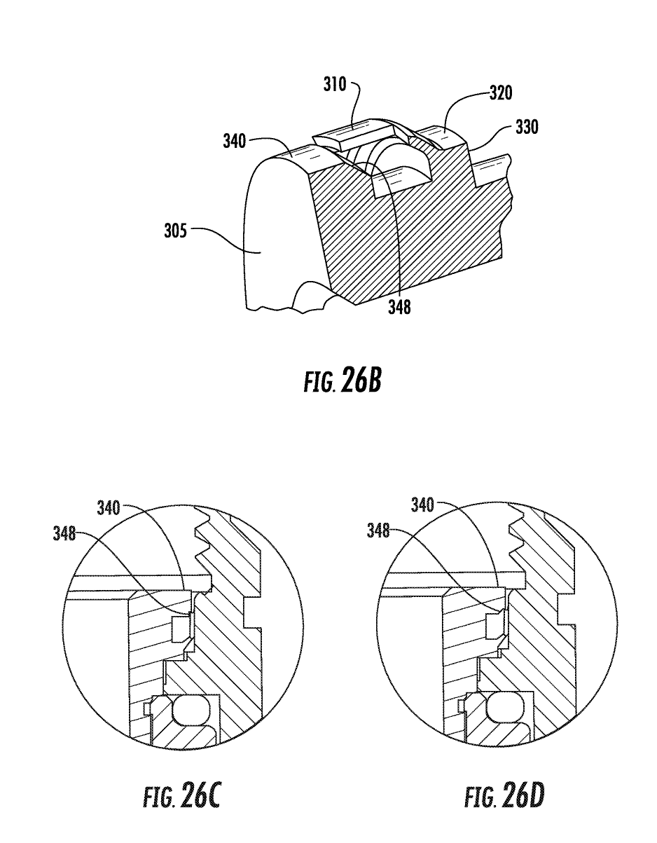

Turning to FIG. 26, wherein a side, cross sectional view of an exemplary embodiment of a partially assembled coaxial cable connector 120 is shown comprising a coupler 200, a body 500 and a post 300, which provides for circuitous electrical paths at the coupler 200. The post 300 further comprises an integral contacting portion 310 and a proximity feature 348. The contacting portion 310 and the proximity feature 348 are monolithic with at least a portion of the post 300. The proximity feature 348 of the post 300 is in juxtaposition with a portion of the contacting portion 310 (best seen in FIGS. 26A and 26B) such that the proximity feature 348 inhibits the contacting portion 310 from over-forming or mis-forming when forming to the contour of the coupler 200. Over-forming may occur if the contacting portion 310 forms to a certain extent past the point of the contour of the coupler 200. Additionally, the proximity feature 348 limits or buffers the effects of any mechanical loading on the contacting portion 310. Proximity feature 348 may be tapered, cylindrical, stepped or just about any other configuration so long as it is in proper proximity with contacting portion 310. As examples, in FIG. 26C the proximity feature 348 is shown as a step formed in the enlarged shoulder 340, while in FIG. 26D, the proximity feature 348 is a chamfer formed in the enlarged shoulder 340. The contacting portion 310 may or may not contact the proximity feature 348 in any given circumstance. In the event that the contacting portion 310 does contact the proximity feature 348 another alternative electrical path may be formed. Additionally, the proximity feature 348 may serve to mechanically bolster or support the contacting portion 310 ensuring mechanical and electrical communication between the integral contact portion 310 and the coupler 200.

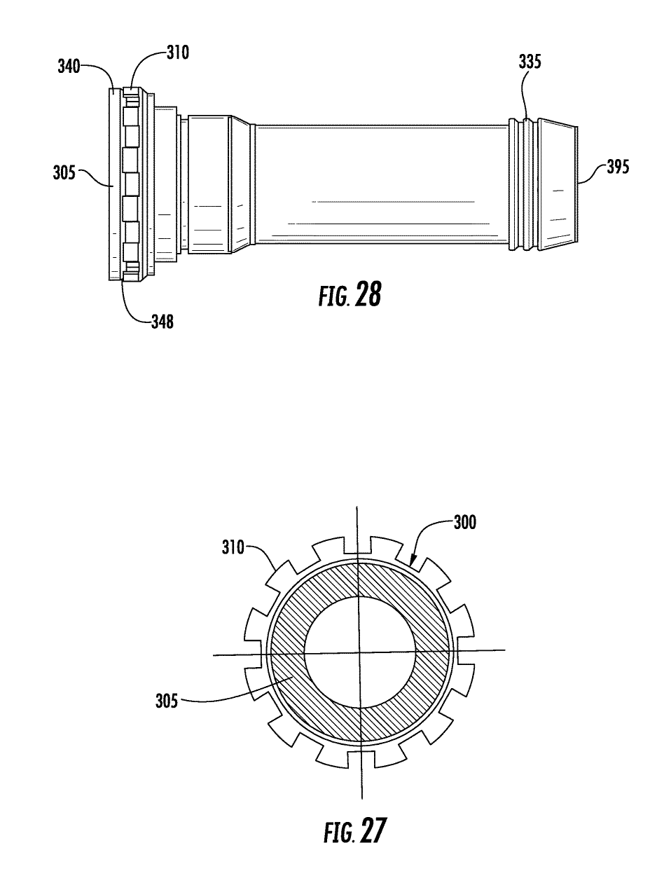

FIG. 27 is a front, cross-sectional view of post 300 showing front end 305 and contacting portion 310 prior to being formed to the contour of the coupler 200. As is clearly illustrated in FIGS. 26, 26B, and 27, when read in light of FIG. 2 and other previously disclosed aspects of coaxial cable connectors described herein, the coupler 200 comprises a lip 215 with a forward facing surface 216 and a rearward facing surface 217, and a bore 230 forward of the lip 215, and is adapted to couple the connector 100 to a coaxial cable terminal. The post 300 further comprises a collar portion 320 and an enlarged shoulder 340 disposed forward of the lip 215 of the coupler 200 within the bore 230 of the coupler 200, generally at the front end of the post 300. The enlarged shoulder 340 of the post is disposed forward of the collar portion 320 of the post 300. The contacting portion 310 of the post 300 comprises an extension of the collar portion 320 of the post 300. At least a portion of the enlarged shoulder 340 of the post 300 comprises the proximity feature 348. The contacting portion 310 of the post 300 contacts the bore 230 of the coupler 200 and bends towards the front end of the connector 200 when the post 300 is assembled with the coupler 200.

The proximity feature 348 may comprise a step, chamfer, or other similarly functioning structure, formed in the enlarged shoulder 340 of the post, to inhibit a degree to which the contacting portion 310 may bend towards the front end of the connector 200 upon contact with the bore 230 of the coupler 200. For example, in FIG. 26B, the proximity feature 348 comprises a chamfer formed in the enlarged shoulder 340 of the post 300. Turning more specifically to FIG. 27, it is noted that the contacting portion 310 may comprise a plurality of circumferentially spaced tabs extending from the collar portion of the post 300. The twelve tabs forming the contacting portion 310 in FIG. 27 define radially expanding trapezoids. The resulting geometry can be used to optimize tab conformity and coupler contact, i.e., by minimizing the extent to which the tabs of the contacting portion 310 share a mechanical interface with the collar portion 320 of the post 300 and maximizing the size of the tabs where they contact the bore 230 of the coupler 200. In some embodiments, it may be preferable to ensure that the contacting portion 310 comprises at least six circumferentially spaced tabs.

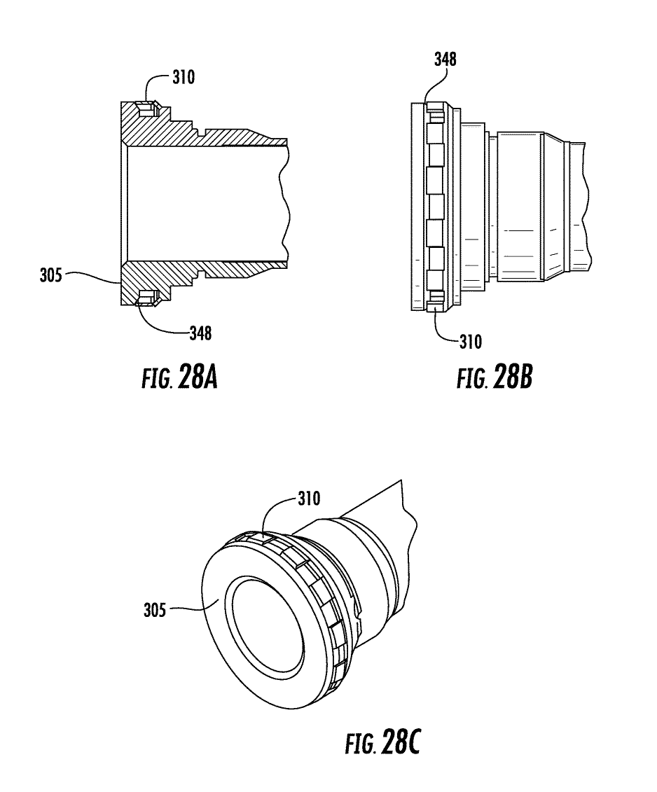

FIG. 28 is a side view of post 300 illustrating enlarged should 340 proximate to the front end 305, barbed portion 335 proximate the back end 395 and contacting portion 310. In FIG. 28 terminal ends 349 of contacting portion 310 are shown supported by proximity feature 348. FIGS. 28A and 28B illustrate a partial cross-sectional view and a partial detail view, respectively, of contacting portion 310 with proximity feature 348. FIG. 28C illustrates a front, perspective view of post 300 and proximity feature 348. FIGS. 28A, 28B and 28C show the contacting portion 310 supported by proximity feature 348.

It will be apparent that various modifications and variations can be made without departing from the spirit or scope of the disclosed embodiments. Since modifications combinations, sub-combinations and variations of the disclosed embodiments incorporating the spirit and substance of the embodiments may occur, the disclosed embodiments should be construed to include everything within the scope of the appended claims and their equivalents.

1. A coaxial cable connector for coupling an end of a coaxial cable to a terminal, the coaxial cable comprising an inner conductor, a dielectric surrounding the inner conductor, an outer conductor surrounding the dielectric, and a jacket surrounding the outer conductor, the connector comprising a coupler, a body, and a post, wherein:
the coupler is assembled with the body and the post, is adapted to couple the connector to the terminal, and comprises an inside bore having contours;
the post is adapted to receive an end of a coaxial cable, and comprises a contacting portion that is monolithic with the post;
the contacting portion of the post comprises a plurality of circumferentially spaced tabs extending radially from a collar portion of the post;
the tabs expand radially towards an interface with the contoured bore of the coupler such that the tabs contact the contoured bore of the coupler along a contacting interface that exceeds a mechanical interface between the tabs and the collar portion of the post, and such that the contacting portion of the post forms to the contours of the coupler when the post is assembled with the coupler and provides for electrical continuity through the connector to the terminal.

2. The coaxial cable connector of claim 1, wherein the tabs of the contacting portion define radially expanding trapezoids.

3. The coaxial cable connector of claim 2, wherein opposing edges of adjacent ones of the radially expanding trapezoids are displaced from and parallel to a ray extending from a central longitudinal axis of the contoured bore of the coupler, in a planar cross section of the coupler orthogonal to the central longitudinal axis.

4. The coaxial cable connector of claim 1, wherein the tabs of the contacting portion are arranged circumferentially about the collar portion of the post at approximately 30 degree intervals.

5. The coaxial cable connector of claim 1, wherein the tabs of the contacting portion define radially expanding trapezoids and are arranged circumferentially about the collar portion of the post at approximately 30 degree intervals.

6. The coaxial cable connector of claim 1 wherein the contacting portion comprises at least six circumferentially spaced tabs extending from the collar portion of the post.

7. The coaxial cable connector of claim 1 wherein the contacting portion comprises twelve circumferentially spaced tabs extending from the collar portion of the post.

8. The coaxial cable connector of claim 1, wherein:
the coaxial cable connector comprises a front end and a back end;
the coupler comprises a front end disposed towards the front end of the connector and a back end disposed towards the back end of the connector;
the post comprises a front end disposed towards the front end of the connector and a back end disposed towards the back end of the connector;
the coupler further comprises a central passage, a lip with a forward facing surface and a rearward facing surface, and a bore forward of the lip;
the collar portion of the post is disposed forward of the lip of the coupler within the bore of the coupler.

9. The coaxial cable connector of claim 8, wherein the tabs of the contacting portion define radially expanding trapezoids.

10. The coaxial cable connector of claim 9, wherein opposing edges of adjacent ones of the radially expanding trapezoids are displaced from and parallel to a ray extending from a central longitudinal axis of the contoured bore of the coupler, in a planar cross section of the coupler orthogonal to the central longitudinal axis.

11. The coaxial cable connector of claim 8, wherein the tabs of the contacting portion are arranged circumferentially about the collar portion of the post at approximately 30 degree intervals.

12. The coaxial cable connector of claim 8, wherein the tabs of the contacting portion define radially expanding trapezoids and are arranged circumferentially about the collar portion of the post at approximately 30 degree intervals.

13. The coaxial cable connector of claim 8 wherein the contacting portion comprises at least six circumferentially spaced tabs extending from the collar portion of the post.

14. The coaxial cable connector of claim 8 wherein the contacting portion comprises twelve circumferentially spaced tabs extending from the collar portion of the post.

15. A coaxial cable connector comprising a front end, a back end, a coupler, a body, and a post, wherein:
the coupler is assembled with the body and the post, is adapted to couple the connector to a terminal, and comprises a front end disposed towards the front end of the connector, a back end disposed towards the back end of the connector, a lip with a forward facing surface and a rearward facing surface, and a contoured bore forward of the lip;
the post comprises a collar portion disposed forward of the lip of the coupler within the contoured bore of the coupler, is adapted to receive an end of a coaxial cable, and comprises a front end disposed towards the front end of the connector, a back end disposed towards the back end of the connector, and a contacting portion;
the contacting portion of the post is monolithic with the post and comprises a plurality of circumferentially spaced tabs arranged circumferentially about, and extending from, a collar portion of the post;
the tabs of the contacting portion of the post expand radially from a mechanical interface with the collar portion of the post towards a terminus at which the tabs interface with the contoured bore of the coupler to provide for electrical continuity through the connector, to the terminal.

16. The coaxial cable connector of claim 15, wherein the tabs of the contacting portion define radially expanding trapezoids.

17. The coaxial cable connector of claim 16, wherein opposing edges of adjacent ones of the radially expanding trapezoids are displaced from and parallel to a ray extending from a central longitudinal axis of the contoured bore of the coupler, in a planar cross section of the coupler orthogonal to the central longitudinal axis.

18. The coaxial cable connector of claim 15, wherein the tabs of the contacting portion are arranged circumferentially about the collar portion of the post at approximately 30 degree intervals.

19. The coaxial cable connector of claim 15 wherein the contacting portion comprises at least six circumferentially spaced tabs extending from the collar portion of the post.

20. The coaxial cable connector of claim 15 wherein the contacting portion comprises twelve circumferentially spaced tabs extending from the collar portion of the post.
